(19) United States
(12) Patent Application Publication
(10) Pub. No.: US 2011/0113861 A1
(43) Pub. Date: May 19, 2011

(54) LEAK DETECTOR AND METHOD OF DETECTING LEAK

(76) Inventors: Takayuki MAEHIRA, Kanagawa (JP); Ryuichi Wakamatsu, Kanagawa (JP); Eiichi Sato, Kanagawa (JP)

(21) Appl. No.: 12/696,377

(22) Filed: Jan. 29, 2010

(30) Foreign Application Priority Data
Nov. 19, 2009 (JP) 2009-264064

(51) Int. Cl. G01M 3/20

(52) U.S. Cl. 73/40.7

(57) ABSTRACT

A leak detector detects the presence or absence of a trace amount of leak from a test piece by using helium gas. The leak detector has a guide pipe and a mass spectrometer. The guide pipe is disposed by insertion into an evacuation pipe which is communicated from a vacuum chamber, in which the test piece is disposed, to a vacuum pump. The guide pipe includes an opening portion which opens in a line of flow inside the evacuation pipe. The mass spectrometer for detecting helium is connected to the guide pipe through a gate valve.

This application claims the priority benefit under 35 U.S.C. §119 of Japanese Patent Application No. 2009-264064 filed on Nov. 19, 2009, which is hereby incorporated in its entirety by reference.

### BACKGROUND

1. Technical Field

The present invention relates to a leak detector to be used in detecting the presence or absence of a leak in a test piece such as a hermetically sealed vessel, pipe, valve, and the like, and also relates to a method of detecting a leak.

2. Related Art

It has been known to use a leak detector in a leak test (leak detecting method) to detect (or inspect) the presence or absence of a trace amount of leak from a test piece such as a hermetically sealed vessel, pipe, valve, and the like (see, e.g., patent document 1). The leak detector is provided with a mass spectrometer which is arranged: to ionize the gas molecules in the vacuum; and to select only the helium ions to cause them to be incident on an ion collector, thereby quantitatively detecting as the ion current the helium gas that has been leaked into the vacuum. The mass spectrometer is mounted, through a gate valve, on a branch pipe that is branched from an evacuation pipe leading from the vacuum chamber in which a vacuum atmosphere can be formed, to a vacuum pump.

A description will now be made of an example in which the above-described conventional leak detector is used, and a leak test is performed by disposing a hermetically sealed vessel such as a tank and the like inside a test chamber (vacuum chamber) in which a vacuum atmosphere can be formed. First, the hermetically sealed vessel as a test piece is housed inside the test chamber. Then, the test piece is filled with helium gas. Also, the test chamber is evacuated to make it into a vacuum atmosphere. Then, in case there is a leak out of the test piece, the presence or absence of the helium gas mixed into the vacuum atmosphere is detected by the leak detector.

In the above-described conventional art, however, the leak test is performed only after the pressure inside the test chamber has reached a predetermined value (e.g., 10 Pa) in order to increase the sensitivity to detect helium. In other words, when the test chamber is evacuated from the atmospheric pressure, the flow condition inside the evacuation pipe is of a viscous flow at the beginning and, therefore, the helium that is guided into the mass spectrometer through the branch pipe is small in amount. Therefore, the leak test is performed by waiting until the test chamber and the evacuation pipe have been reduced to a predetermined pressure (e.g., 10 Pa), whereby the helium is freely diffused so as to become guided into the mass spectrometer through the branch pipe. As a result, there is a disadvantage in that much time is required before the leak test can be started.
Patent document 1: JP-A-1998-38746.

### SUMMARY

In view of the above-described problem, this invention has a problem of providing a leak detector and a method of detecting a leak in which the leak test can be efficiently performed in a shorter time.

In order to solve the above problems, according to an embodiment of this invention, there is provided a leak detector for detecting a trace amount of leak from a test piece by using helium gas. The leak detector comprises: a guide pipe disposed by insertion into an evacuation pipe which is communicated from a vacuum chamber in which the test piece is disposed to a vacuum pump, the guide pipe having an opening portion which opens in a direction of line of flow inside the evacuation pipe; and a mass spectrometer for detecting helium, the mass spectrometer being connected to the guide pipe through a gate valve.

According to the above arrangement, the test piece is filled with helium gas and then the test piece is disposed into the vacuum chamber. Thereafter, the vacuum chamber is evacuated to form therein a vacuum atmosphere. Alternatively, after having disposed a test piece into the vacuum chamber, the vacuum chamber is evacuated while the test piece is filled with helium gas, thereby forming a vacuum atmosphere inside the vacuum chamber. At this time, if there is a leak from the test piece, the helium leaked from this test piece will be guided into the evacuation pipe through the vacuum chamber. According to this invention, since the guide pipe is disposed by insertion into the evacuation pipe, part of the leaked helium that has been guided into the evacuation pipe right after the starting of the operation of evacuating the vacuum chamber, will be guided into the guide pipe. In this state, when the gate valve is opened after the pressure inside the vacuum chamber has been reduced to a predetermined value, the helium in the guide pipe will be started to be guided into the mass spectrometer. As a result, without waiting for the free diffusion of the helium that has leaked from the test piece, the helium that is sufficient in amount to perform therewith a leak test at a predetermined sensitivity will reach the mass spectrometer.

As described above, according to an embodiment of this invention, the helium that is guided into the evacuation pipe simultaneously with the starting of the operation of evacuating the vacuum chamber, is efficiently guided into the mass spectrometer through the guide pipe inside the evacuation pipe. A leak test can thus be performed at an early time. As a result, as compared with the conventional art in which the free diffusion of helium must be waited for before the leak test can be started, the time to the starting of the leak test can be shortened and, therefore, the time required to perform a leak test of the test piece can largely be reduced. Incidentally, the test piece according to this invention refers to parts or components that require air-tightness such as hermetically sealed packages like tanks, packages, and the like, and parts or components such as pipes, valves, and the like. The leak detector according to this invention can also be used in leak detection of the vacuum chamber itself.

According to another aspect of this invention, preferably the guide pipe has a tubular portion of a predetermined length, and the tubular portion is disposed in a coaxial relationship with the evacuation pipe. According to this arrangement, there will be defined an evacuation passage of a predetermined length between the tubular portion of the guide pipe and an inner wall of the evacuation pipe, thereby securing isotropic evacuation, so that the amount of lowering in the evacuation speed can be minimized

According to a further aspect of this invention, preferably the opening portion of the tubular portion is expanded in diametrical direction toward an end portion thereof. According to this arrangement, it is possible to more efficiently bring the helium that is guided into the evacuation pipe toward the mass spectrometer through the guide pipe. In this invention, in order to restrict the lowering in the evacuation speed, the outside diameter of the guide pipe shall preferably fall within a range of from ⅕ to ¼ of the inner diameter, e.g., about ¼. The outside diameter of the opening portion at the front end of the guide pipe shall preferably be from about ¼ to ⅓ of the inner diameter of the evacuation pipe.

According to still further aspect of this invention, in order to solve the above problems, the method of detecting a leak comprises the steps of: evacuating a vacuum chamber having disposed therein a test piece which has already been filled with helium gas, or evacuating a vacuum chamber having disposed therein a test piece while filling the test piece with helium gas; and guiding, to a mass spectrometer, part of helium simultaneously with starting of the step of evacuating the vacuum chamber. The helium is guided into an evacuation pipe that is communicated from the vacuum chamber to a vacuum pump, thereby starting a leak test without waiting for free diffusion of the helium.

The pressure in the vacuum chamber at the time of starting the leak test shall be within a range of from 100 Pa to 10 Pa, preferably about 100 Pa. Outside the above-described pressure range, there will occur an overload on a turbo molecular pump when the turbo molecular pump is used as the vacuum pump.

### BRIEF DESCRIPTION OF THE DRAWINGS

FIG. 1 is a schematic diagram showing an arrangement in which a leak test is performed by using the leak detector according to this invention;

FIG. 2 is an enlarged side view, partly shown in section, showing part of FIG. 1; and

FIG. 3 is a graph showing the timing of starting the leak test by the leak detector according to this invention.

### DESCRIPTION OF EXEMPLARY EMBODIMENTS

With reference to the accompanying drawings, a description will now be made of an embodiment of a leak detector according to this invention. In this embodiment, a hermetically sealed vessel such as a tank and the like is defined as a test piece TP. This test piece TP is subjected to a leak test by disposing it inside a test chamber (vacuum chamber) in which a vacuum atmosphere can be formed.

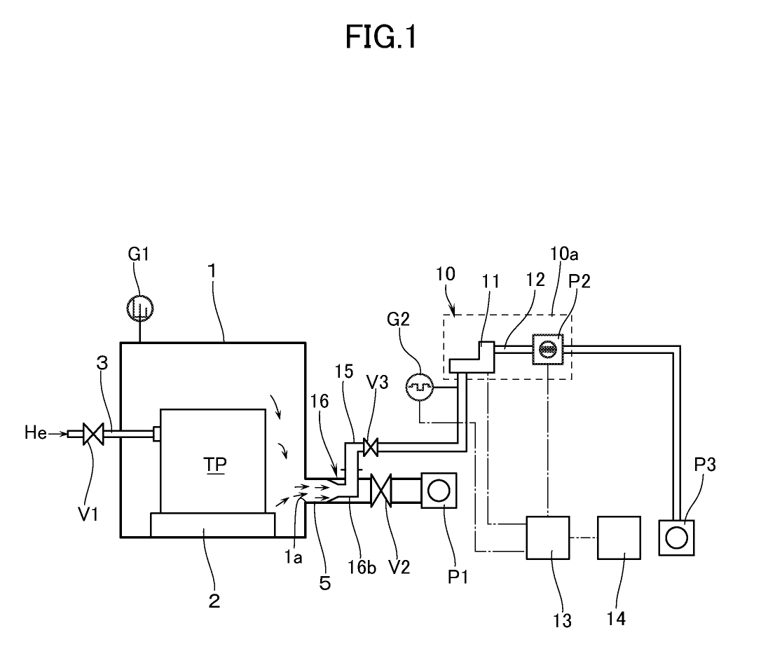

With reference to FIG. 1, reference numeral 1 denotes a test chamber (vacuum chamber) in which a leak test is performed. The test chamber 1 has a predetermined volume and is provided, at the bottom thereof, with a supporting base 2 which holds thereon the test piece TP. On a side surface of the test chamber 1 there is disposed by insertion a flexible pipe 3 through a vacuum seal such as an O-ring and the like (not illustrated). That end of the pipe 3 which lies inside the test chamber 1 is connected, through a flange with an O-ring (not illustrated), to the test piece TP held on the supporting base 2. On the other hand, the other end of the pipe 3 lying outside the test chamber 1 is connected, through a gate valve V1, to a helium gas source (not illustrated) in which helium gas is stored. The pipe 3 has connected thereto, through changeover valves, other pipes (not illustrated) and vacuum pumps. It is thus so arranged that the air and inert gas can be supplied to the test piece TP, and also that evacuation inside the test piece TP can be made. In this case, the pipe for evacuating purpose may be connected to a vacuum pump (to be described hereinafter) so that the single piece of vacuum pump can serve the dual purpose also of evacuating the test chamber 1.

The test chamber 1 has formed therein an evacuation port 1a. This evacuation port 1a has connected thereto an evacuation pipe 5 with a gate valve V2 interposed therein, and this evacuation pipe 5 is communicated with a vacuum pump P1. As the vacuum pump P1, an appropriate one may be selected out of a rotary pump, a turbo molecular pump, and the like depending on the volume of the test chamber 1 and the pressure range inside the test chamber 1 at the time of performing the leak test. In addition, the test chamber 1 is provided with a vacuum gauge G1 such as a Pirani gauge, an ion gauge, and the like for use in the test chamber. The evacuation pipe 5 has attached thereto a mass spectrometer 11 of a leak detector 10. A description will now be made of an arrangement of the leak detector 10 according to this embodiment.

The leak detector 10 has a housing 10a. The housing 10a has built therein the mass spectrometer 11, and a turbo molecular pump (vacuum pump) P2 which is connected to the mass spectrometer 11 through an evacuation pipe 12. The operation of the leak detector 10 inclusive of these components is central-controlled by a control unit 13 which is provided with a microcomputer and the like. The turbo molecular pump has connected thereto a backing pump P3 such as a rotary pump and the like.

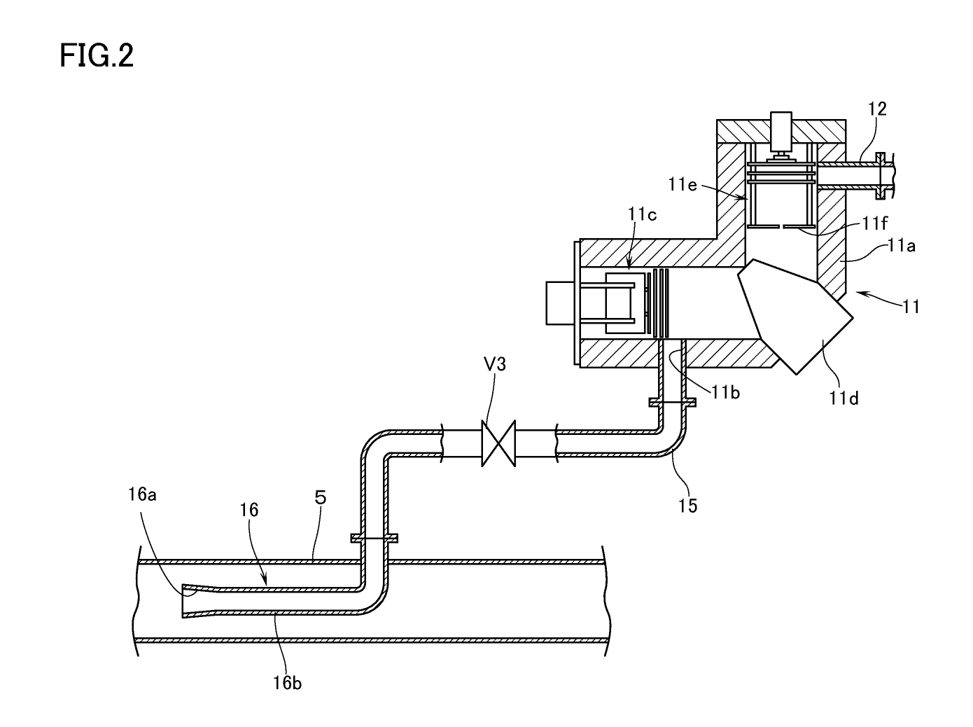

As shown in FIG. 2, the mass spectrometer 11 is provided with a main body 11a which is bent into substantially L-shape. The main body 11a has therein: an ion source 11c which ionizes the gas molecules in the vacuum, the gas molecules being guided into the main body 11a through a gas intake port 11b which is in communication with a pipe (to be described hereinafter); a magnet 11d which forms a magnetic field for deflecting, depending on an atomic mass number, the ions that have been discharged out of the ion source 11c at a certain accelerating voltage; and an ion collector 11e which collects the helium ions. Out of the gas ions that have been deflected by the magnet 11d, only the helium ions are arranged to reach the ion collector 11e through a slit plate 11f. The ion current that flows through the ion collector 11e is detected by an ammeter (not illustrated), and the ion current value at that time is outputted to the control unit 13. The amount of leak of helium is detected by the ion current at this time. As an alternative solution, there may be provided a display 14 so that the amount of leak of helium can be displayed. In FIG. 1, the dashed lines show control signal lines between the control unit 13 and the respective parts.

A pipe 15 having interposed therein a gate valve V3 is connected to the gas intake port 11b of the mass spectrometer 11. This pipe 15 has connected thereto a guide pipe 16 which is disposed by insertion into the evacuation pipe 5 and which has an opening portion 16a opening in the direction of line of flow (direction as shown by arrows in FIG. 1) inside the evacuation pipe 5. The pipe 15 is provided with a vacuum gauge G2 such as a Pirani gauge, ion gauge and the like so that the pressure inside the pipe 15 leading to the mass spectrometer 11 can be measured. The guide pipe 16 has a predetermined length of tubular portion 16b which is disposed inside the evacuation pipe 5 in a coaxial relationship with the evacuation pipe 5. One end of this tubular portion 16b is bent so as to pass through the pipe wall of the evacuation pipe 5 toward the outside thereof. The opening portion 16a, which is the other end of the tubular portion 16b, is diametrically expanded so as to become larger in diameter toward the front end, i.e., toward the evacuation port 1a. It is thus so arranged that the helium gas guided into the evacuation pipe 5 while the test chamber 1 has been evacuated is positively guided into the mass spectrometer 11. In this case, the outside diameter of the tubular portion 16b of the guide pipe 16 shall preferably be made to fall within a range of from about ⅕ to ¼ (e.g., ¼) of the inside diameter of the evacuation pipe 5. The outside diameter at the front end of the opening portion 16a, on the other hand, shall preferably be made to fall within a range of from about ¼ to ⅓ of the inside diameter of the evacuation pipe 5.

A description will now be made of the leak test which is a method of leak detection of an embodiment of this invention by using the above-described leak detector 10. First, a test piece TP is placed in position on the supporting base 2 inside the test chamber 1 in atmospheric state, and one end of the pipe 3 is connected to the test piece TP. Gross leak test of the test piece TP is performed in this state. The gross leak test is performed in the following manner. Gas such as nitrogen, air and the like is guided into the test piece TP through the pipe 3 to internally pressurize the test piece TP. The pressure variations in the gas to be filled in at this time is used in performing the gross leak test.

When the gross leak test has been finished, a vacuum pump (not illustrated) for evacuating the test piece TP is operated in a state in which, e.g., the gate valve V2 is kept closed, thereby evacuating the gas out of the test piece TP. When the pressure inside the test piece TP has reached a predetermined value (e.g., 1000 Pa), the evacuating operation is stopped, and the test piece TP is filled with helium gas through the pipe 3. When the helium gas has been filled to a predetermined pressure, the gate valve V1 is closed to thereby seal the helium inside the test piece TP. Along with these operations, the gate valve V2 is opened to evacuate the test chamber 1 by means of the vacuum pump P1.

On the other hand, as to the leak detector 10, the control unit 13 performs the following operations, i.e.: in a state in which the gate valve V3 is kept closed, the vacuum pump P2 is operated to evacuate the mass spectrometer 11. Then, calibration is performed on the mass spectrometer 11 in a known method, thereby keeping the leak detector 10 in a standby state. Thereafter, when the pressure inside the test chamber 1 has reached a predetermined value, the gate valve V3 is opened to thereby start the leak test. The pressure inside the test chamber 1 at the time of starting the leak test (i.e., at the time when the gate valve V3 is opened) shall be within a range of from 100 Pa to 10 Pa, preferably about 100 Pa. Outside the above-described pressure range, there will occur an overload on the turbo molecular pump P2. If there is a leak of helium from the test piece TP, the helium that is guided into the evacuation pipe 5 will be positively guided into the mass spectrometer 11 through the guide pipe 16 right after starting the evacuation of the test chamber 1. The helium is thus collected by the ion collector 11e of the mass spectrometer 11, and the ion current flowing through the ion collector 11e is detected by an ammeter. The ion current as detected by the ion collector 11e will be outputted to the control unit 13. The amount of leak of helium is thus detected by the value of the ion current at this time.

When the leak test of the test piece TP has been finished, the gate valve V3 is closed and the leak detector 10 is returned to a stand-by state. In the test chamber 1, on the other hand, the gate valve V1 in the pipe 3 is closed and a vent valve (not illustrated) is operated to return the test chamber 1 to the atmospheric state.

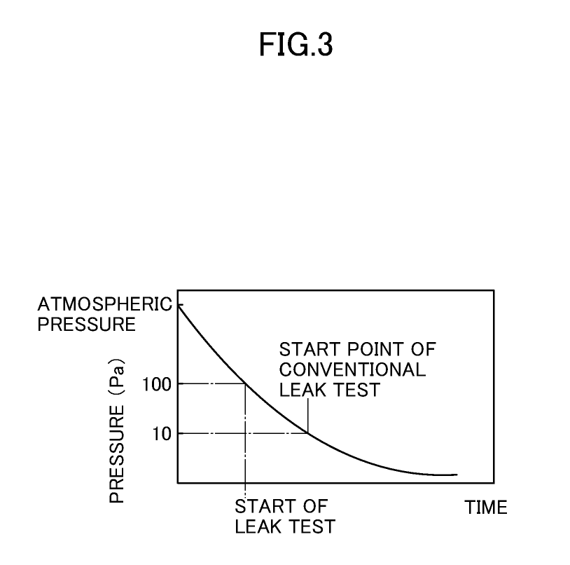

A description will now be made with reference to of the graph in FIG. 3. In the case of the above-described conventional leak detector, when the test chamber is evacuated from the atmospheric pressure, there will be, at the beginning, a small amount of helium that is guided into the mass spectrometer through the branch pipe since the flow conditions inside the evacuation pipe are of viscous flow. Therefore, the leak test can be performed only after the vacuum chamber and the evacuation pipe have been reduced down to a predetermined pressure (e.g., 10 Pa), where free dispersion of helium takes place and, as a consequence, the helium comes to be guided into the mass spectrometer through the branch pipe.

On the other hand, in the leak detector 10 and in the method of detecting a leak according to an embodiment of this invention, if the test piece TP has a leak when the test chamber 1 is evacuated, the helium that has leaked out of the test piece TP is guided, right after the evacuation of the test chamber 1, into the evacuation pipe 5 through the test chamber 1. At this time, the helium that has been guided into the evacuation pipe 5 comes to be partly guided into the mass spectrometer 11 through the guide pipe 16. As a result, without waiting for the free diffusion of helium that has been leaked from the test piece TP, helium in an amount sufficient to justify a leak detection at a predetermined sensitivity will reach the mass spectrometer 11. Consequently, up to the free diffusion pressure of helium, the leak test can be started at a predetermined pressure (e.g., 100 Pa) at which the test chamber 1 and the evacuation pipe 5 are evacuated. This brings about a large reduction in time required to perform the leak test of the test piece TP. In addition, this invention has an arrangement in that the mass spectrometer 11 is mounted on the evacuation pipe 5 which is communicated from the test chamber 1 to the vacuum pump P1. Therefore, there is no need of providing the test chamber 1 with a flange and the like for mounting the mass spectrometer 11 on the test chamber 1. In this manner, the test chamber 1 can be simplified in its construction.

Further, in this embodiment, the guide pipe 16 has a tubular portion 16b of a predetermined length and the tubular portion 16b is disposed in a coaxial relationship with the evacuation pipe 5. Therefore, there is defined an evacuation passage of a predetermined length between the tubular portion 16b and the inner wall of the evacuation pipe 5. Evacuation can thus be made in an isotropic manner, thereby minimizing the amount of decrease in the evacuation speed. On the other hand, since the front end of the opening portion 16a is expanded in diametrical direction, the helium that is guided into the evacuation pipe 5 can be guided into the mass spectrometer 11 through the guide pie 16 in a more efficient manner.

In the above-described embodiment, a description has been made of an example in which the guide pipe 16 has a tubular portion 16b. However, without being limited thereto, the shape and the like of the guide pipe 16 are free as long as the helium gas that has been guided into the evacuation pipe 5 can be brought into the mass spectrometer 11 right after the starting of the operation of evacuating the test chamber 1.

Further, the test chamber 1 is arranged to be provided with the pipe 3 and, in a state in which the test piece TP is disposed therein, the operation can be performed of filling the test piece TP with helium gas along with the operation of evacuating the test chamber 1. It may, alternatively, be so arranged that the test piece TP is carried into the test chamber 1 in a state of having filled the test piece TP with helium, thereby performing a leak test in the test chamber 1.

Sill furthermore, in the above embodiment, a description was made of an example in which the test piece TP is housed inside the test chamber 1 to perform a leak test of the test piece TP. However, this invention is not limited thereto but may be applied to an arrangement in which a processing chamber, e.g., of a sputtering apparatus or an etching apparatus is made to be a test piece to thereby perform a leak test of the processing chamber.

### DESCRIPTION OF REFERENCE NUMERALS

1: test chamber (vacuum chamber)
5: evacuation pipe
10: leak detector
11: mass spectrometer
16: guide pipe
16a: opening portion
16b: tubular portion
P1, P2: vacuum pump
TP: test piece

What is claimed is:

1. A leak detector for detecting presence or absence of a trace amount of leak from a test piece by using helium gas, the leak detector comprising:
a guide pipe disposed by insertion into an evacuation pipe which is communicated from a vacuum chamber in which the test piece is disposed to a vacuum pump, the guide pipe having an opening portion which opens in a direction of line of flow inside the evacuation pipe; and
a mass spectrometer for detecting helium, the mass spectrometer being connected to the guide pipe through a gate valve.

2. The leak detector according to claim 1, wherein the guide pipe has a tubular portion of a predetermined length, and wherein the tubular portion is disposed in a coaxial relationship with the evacuation pipe.

3. The leak detector according to claim 2, wherein the opening portion of the tubular portion is expanded in diametrical direction toward an end portion thereof.

4. A method of detecting a leak comprising the steps of:
evacuating a vacuum chamber having disposed therein a test piece which has already been filled with helium gas, or evacuating a vacuum chamber having disposed therein a test piece while filling the test piece with helium gas; and
guiding, to a mass spectrometer, part of helium simultaneously with starting of the step of evacuating the vacuum chamber, the helium being guided into an evacuation pipe communicated from the vacuum chamber to a vacuum pump, thereby starting a leak test without waiting for free diffusion of the helium.

5. The method according to claim 4, wherein a pressure inside the vacuum chamber at a time of starting the leak test is set to a range of from 100 Pa to 10 Pa.
